(19) United States
(12) Patent Application Publication
(10) Pub. No.: US 2004/0164003 A1
(43) Pub. Date: Aug. 26, 2004

(54) Vibratory motor supporting structure

(76) Inventor: James A. Mooney, Tonawanda, NY (US)

Correspondence Address: JOSEPH P. GASTEL, 295 MAIN ST., SUITE 722, BUFFALO, NY, 14203, US

(21) Appl. No.: 10/367,206

(22) Filed: Feb. 14, 2003

(51) Int. Cl. B07B 1/44; B07B 1/49

(52) U.S. Cl. 209/367; 209/405

(57) ABSTRACT

A support structure for mounting a vibratory motor on a vibratory frame of a vibratory screening machine consisting of spaced flexures for mounting between the ends of a vibratory motor and the spaced sides of a vibratory frame of a vibratory screening machine, each of the flexures having a first end for connecting to the vibratory motor, and a second end for connecting to the vibratory frame of the vibratory screening machine, each of the flexures having a width dimension and a thickness dimension which is smaller than the width dimension, with the width dimensions extending substantially perpendicularly to the spaced sides, and the thickness dimensions extending substantially perpendicularly to the width dimensions.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to improved support structure for mounting a single vibratory motor on a vibratory frame of a vibratory screening machine to produce elliptical motion.

By way of background, in the past, single vibratory motors have been mounted on the vibratory frames of vibratory screening machines to impart vibratory motion thereto for conveying the material to be screened along the bed of the vibratory frame. The single motors caused the vibratory frames to gyrate in a circular path. In the past, two vibratory motors have been mounted on a vibratory frame in such a manner as to produce elliptical motion for the purpose of separating the components which are being screened in a desired manner. However, it is not known that the prior art included motor supporting structure which would cause a single motor to produce an elliptical motion of the vibratory frame.

### BRIEF SUMMARY OF THE INVENTION

It is one object of the present invention to provide an improved relatively simple and effective supporting structure for mounting a single vibratory motor on the vibratory frame of a vibratory screening machine to produce an elliptical motion of the vibratory frame.

Another object of the present invention is to provide an improved supporting structure for mounting a single vibratory motor of a given capacity on the vibratory frame of a vibratory screening machine to produce a desired elliptical motion and which can be replaced by other supporting structures having different parameters or by adjusting the length of the supporting structure components to produce different elliptical motions. Other objects and attendant advantages of the present invention will readily be perceived hereafter.

The present invention relates to a support structure for mounting a vibratory motor on a vibratory frame of a vibratory screening machine comprising spaced flexure members for mounting between the ends of a vibratory motor and the vibratory frame of a vibratory screening machine, each of said flexure members having a first end for connecting to said vibratory motor, and a second end for connecting to said vibratory frame of said vibratory screening machine.

The present invention also relates to a flexure for supporting a vibratory motor on a vibratory frame of a vibratory screening machine comprising a body having first and second ends, a flexible central portion on said body having a width which is larger than its thickness, first means for securing said first end of said body to a vibratory motor, and second means for securing said second end of said body to the vibratory frame of a vibratory screening machine.

The present invention also relates to an improvement in a vibratory screening machine having a vibratory frame with opposite sides and a single vibratory motor having opposite ends for vibrating said vibratory frame, the improvement consisting of a vibratory motor support structure between said vibratory frame and said single vibratory motor comprising flexures having first ends mounted on said opposite ends of said vibratory motor and second ends mounted on said opposite sides of said vibratory frame, each of said flexures having a width dimension and a thickness dimension which is smaller than said width dimension, said width dimensions extending substantially perpendicularly to said opposite sides, and said thickness dimensions extending substantially perpendicularly to said width dimension.

The various aspects of the present invention will be more fully understood when the following portions of the specification are read in conjunction with the accompanying drawings wherein:

### BRIEF DESCRIPTION OF THE SEVERAL VIEWS OF THE DRAWING

FIG. 1 is a schematic plan view of a vibratory screening machine mounting the improved motor support structure of the present invention;

FIG. 2 is a diagrammatic view of the manner in which a vibratory motor mounted by the improved support structure coacts with the vibratory frame of a vibratory screening machine;

FIG. 3 is a fragmentary perspective view of a vibratory motor mounted on the vibratory frame of a vibratory screening machine by the improved support structure of the present invention;

FIG. 4 is an enlarged side elevational view of one end of the vibratory motor mounted on the side of the vibratory frame;

FIG. 5 is a fragmentary cross sectional view taken substantially along line 5-5 of FIG. 4;

FIG. 6 is a plan view of a flexure which is a component of the vibratory motor support structure and showing the width dimension thereof;

FIG. 7 is a side elevational view of the flexure and showing the thickness dimension thereof;

FIG. 8 is an end elevational view of the flexure taken substantially in the direction of arrows 8-8 of FIG. 7;

FIG. 9 is a fragmentary enlarged view of the end portion of a flexure and showing different thicknesses thereof;

FIG. 10 is a view of different ellipses corresponding to the different thicknesses shown in FIG. 9;

FIG. 11 is a fragmentary side elevational view showing an adjustable mounting for each end of the vibratory motor support structure;

FIG. 12 is a fragmentary side elevational view of a support structure which permits the length of the flexures to be varied;

FIG. 13 is an enlarged fragmentary view of the adjusting structure taken substantially in the direction of arrows 13-13 of FIG. 12;

FIG. 14 is a fragmentary cross sectional view taken substantially along line 14-14 of FIG. 12;

FIG. 15 is a fragmentary side elevational view of another embodiment of the present invention; and

FIG. 16 is a fragmentary view taken substantially in the direction of arrows 16-16 of FIG. 15.

### DETAILED DESCRIPTION OF THE INVENTION

By way of background, as is well known in the art, a vibratory screening machine 10 includes an outer frame 11 having stationary sides 12 which mount the sides of a vibratory frame 13 on resilient mounts 15 therebetween. A vibratory motor 17 has its ends 19 mounted on the sides 14 of the vibratory frame by the improved support structure 20 of the present invention. The longitudinal axis 21 of motor 17 extends perpendicularly to the longitudinal axis 22 of the vibratory frame 13. During motor operation the material being screened is conveyed in the direction of arrow 23 along a plurality of screens 24 which are mounted on the bed of the vibratory frame. Except for the improved vibratory motor support structure, the above described type of vibratory screening machine 10 is well known in the art.

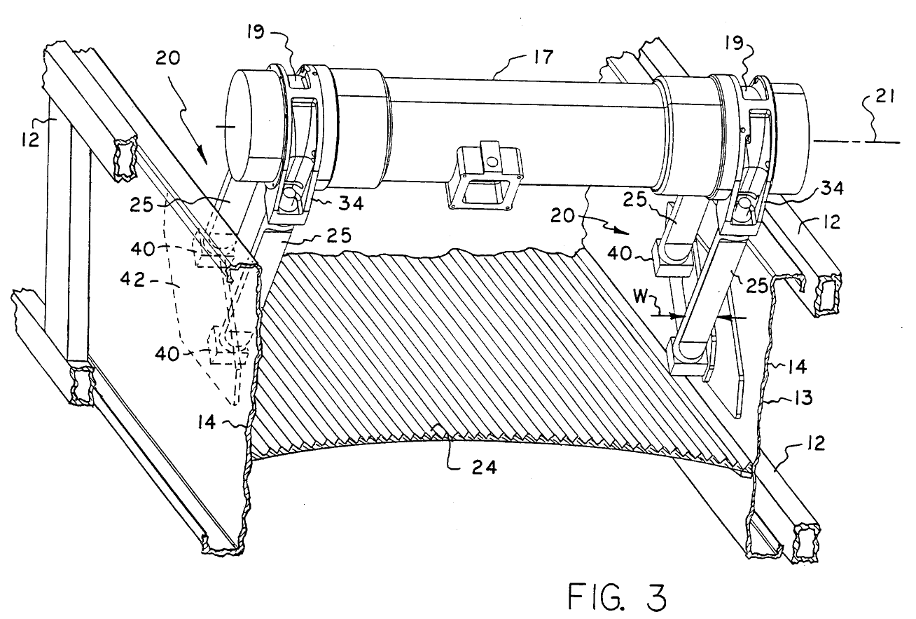

One embodiment of the improved support structure 20 for causing a single motor to produce an elliptical motion of a vibratory frame is shown in FIGS. 3-8, and this structure is mounted at each end of motor 17. It includes two flexures 25 mounted between each end 19 of motor 17 and its adjacent vibratory frame side 14. Each flexure 25 has a body in the form of an elongated metal member having a flexible central portion 27 of substantially rectangular cross section with a width dimension W and a thickness dimension T. The central portion 27 merges into enlarged cylindrical end portions 29 through curved portions 30. Threaded shafts 31 extend outwardly from cylindrical portions 29 which terminate at flat circular faces 32.

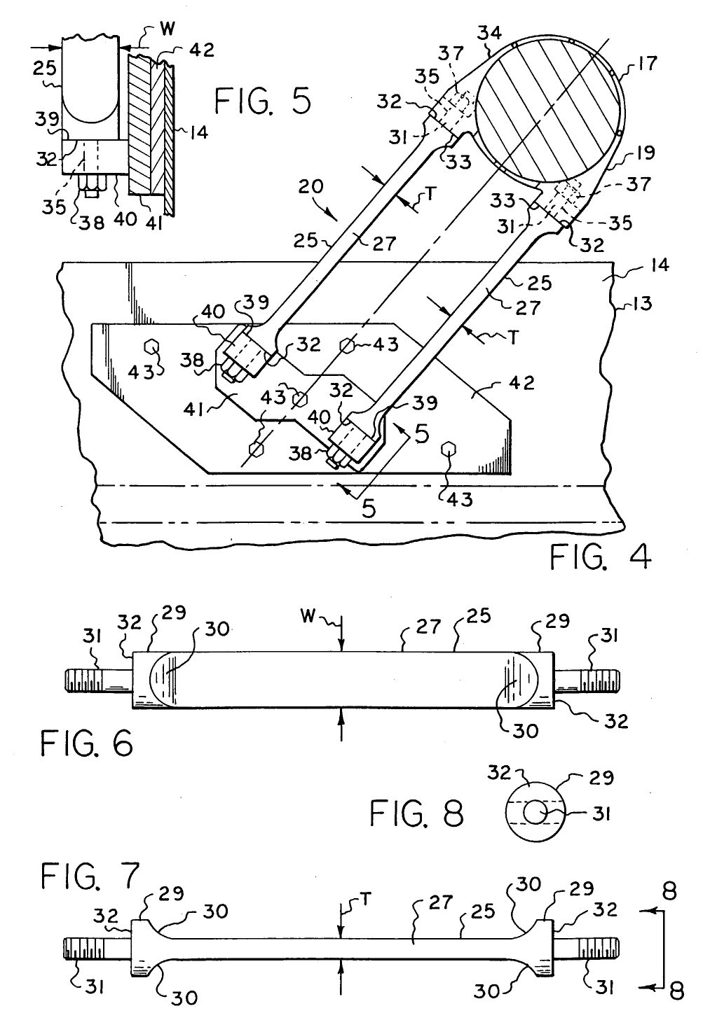

The flexures 25 are mounted between the ends 19 of motor 17 and sides 14 of vibratory frame 13 in the following manner. The upper ends of flexures 25 have their flat surfaces 32 (FIG. 5) pressed into engagement with flat surfaces 33 of motor bracket 34 when threaded shafts 31 are located in bores 35 of bracket 34 and are tightened by nuts 37. The foregoing is performed at both ends 19 of motor 17. The opposite ends of flexures 25 have their flat surfaces 32 pressed against flat surfaces 39 of lugs 40 by the tightened nuts 38 on the threaded shafts 31. The lugs 40 extend outwardly from and are welded to plates 41 which are in turn welded to plates 42 which are bolted to sides 14 of vibratory frame 13 by means of bolts 43 which extend through sides 14 and the plates 41 and 42 as shown in FIG. 4.

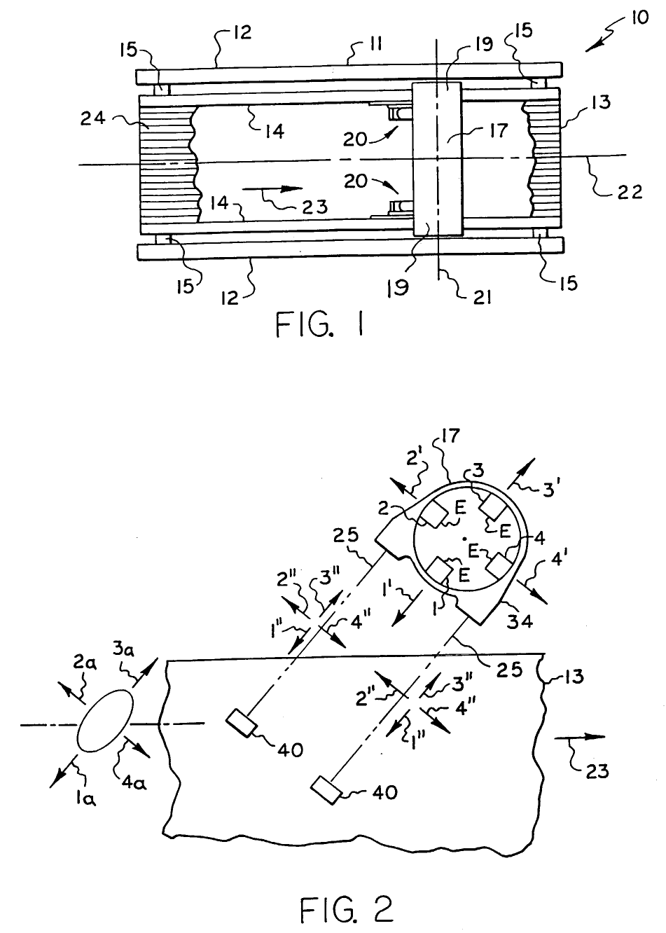

The four flexures 25 are mounted with their width dimensions W extending in a direction substantially perpendicularly to the sides 14 of the vibratory frame 13. Suitable alignment structure may be provided at one or both ends of the flexures 25 to insure that they are oriented in the foregoing attitude. The alignment structure may take any desired form such as a pin which enters aligned holes in the adjacent parts or a pin on one part which enters a hole in the other part. When the flexures are aligned with their width dimensions W extending substantially perpendicularly to the sides 14, they will be rigid in the direction of their widths, but they will be flexible in the direction of their thicknesses. They will also be rigid in the directions of their lengths. Accordingly, they will operate in the following manner, as schematically depicted in FIG. 2. When the vibratory motor is operating with its eccentric weight E in position number 1, the thrust of the motor will be in the direction of arrow 1′, that is, through the longitudinal axes of flexures 25, and the flexures will not yield in any direction so that the thrust is transmitted through the flexures 25 in the direction 1″ so that the vibratory frame 13 will move in the direction 1a. When the eccentric weight E is in the position 2, the thrust of the motor will be in the direction of arrow 2′, and this will cause flexures 25 to yield in the direction of arrows 2″ which in turn will cause the vibratory frame 13 to move in the direction of arrow 2a. When the eccentric weight E is in the position 3, the thrust of the motor is in the direction 3′ and the thrust on the flexures 25 will be in the direction of arrows 3″ and the vibratory frame will also move in the direction of arrow 3a, but the flexures will not deflect. When the eccentric weight is in the position 4, the motor will tend to move in the direction of arrow 4′ and the flexures 25 will yield in the direction of arrows 4″ and the vibratory frame will also tend to move in the direction of arrow 4a. Thus, the vibratory motor acting through the flexures 25 will cause the vibratory frame 13 to move in the direction of the ellipse shown in FIG. 2 as a result of the components 1a-4a and the intermediate components being applied thereto.

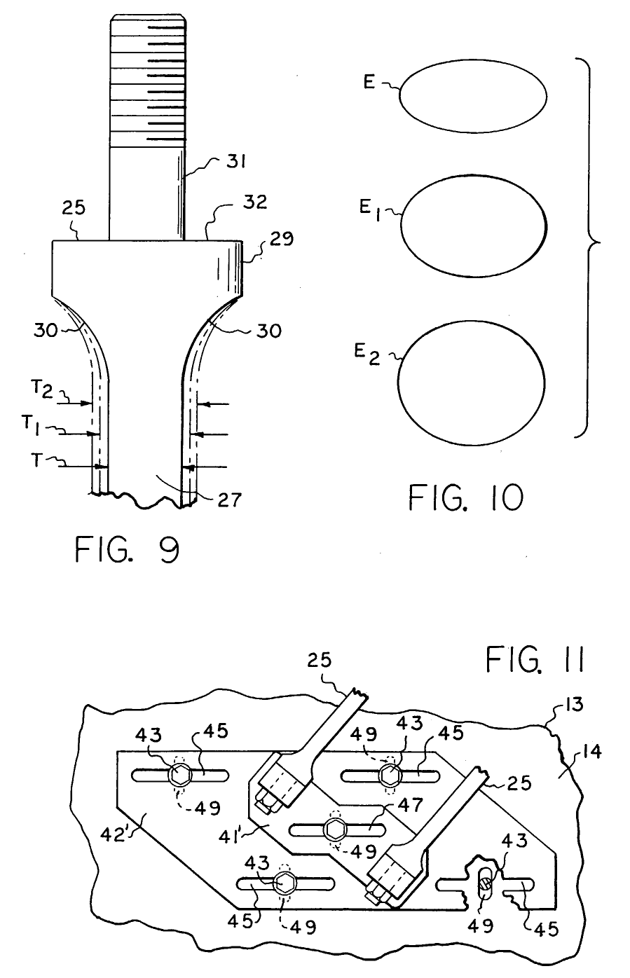

In FIGS. 9 and 10, the effect of various thicknesses of the flexure 25 is depicted. When the thickness is T, the central portion 27 is relatively thin, and a relatively shallow ellipse E will be generated because relatively low thrust is transmitted to the vibratory frame through the flexure in view of the fact that it yields to absorb the thrust. When the thickness is T1, a wider ellipse E1 is generated because more of the eccentric thrust of vibratory motor 17 is transmitted to vibratory frame 13 in view of the fact that the flexure 25 will flex less. When the flexure 25 is of a still greater thickness T2, a still wider ellipse E2 will be generated because still more of the thrust of motor 17 will be transmitted to the vibratory frame 13 in view of the fact that the flexure 25 will flex still less. Thus, by controlling the thickness of the flexures 25, ellipses having dimensions with different desired minor axes can be generated.

In FIG. 11 a modified mounting structure is disclosed which will permit the position of the vibratory motor 17 to be adjusted relative to the vibratory frame 13. In this respect, the upper ends of flexures 25 are secured to motor 17 as described in the preceding figures. However, plates 42′ and 41′, which are modifications of plates 42 and 41, respectively, of FIG. 4 are slotted to permit movement of plate 42′ relative to vibratory frame side 14. Plate 41′ remains welded to plate 42′. Slots 45 are provided in plate 42′, and a slot 47 extends through both plate 41′ and 42′. Vertical slots 49 are provided in vibratory frame wall 14. The bolts 43 extend through slots 45, 47 and 49. Thus, plate 42′ can be shifted as desired in the horizontal direction or the vertical direction or both to thereby orient the motor 17 relative to the vibratory frame 13.

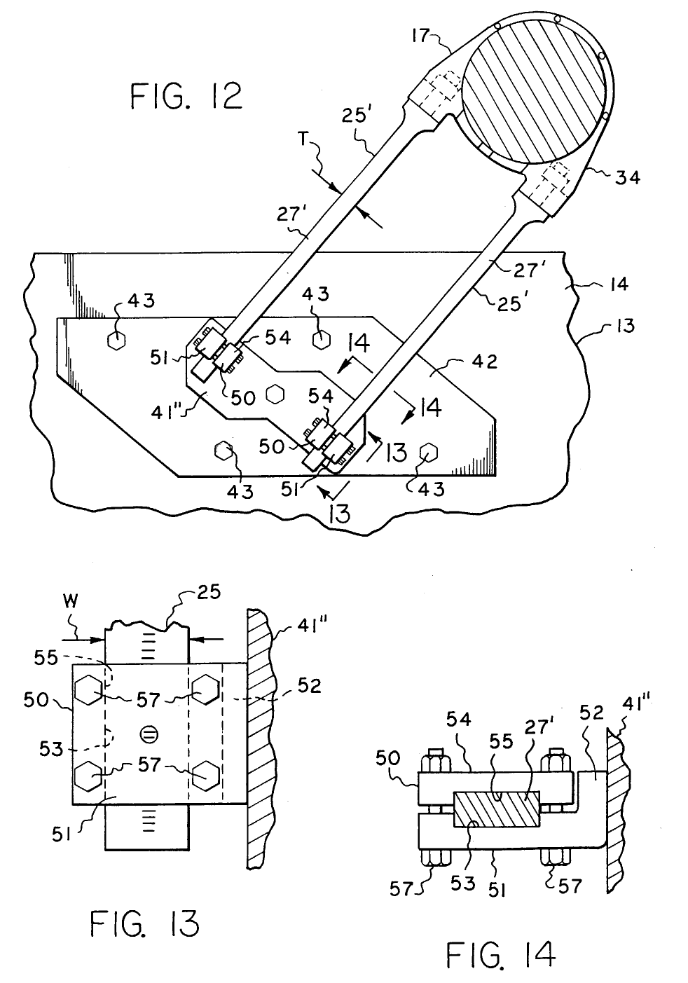

In FIGS. 12-14 a further modification of the present invention is disclosed which permits the shape of the ellipse to be varied by varying the length of the flexures 25′ which are of a different construction than flexures 25 of the preceding figures. In the foregoing respects, the portions of flexures 25′ which attach to brackets 34 at the ends of motor 17 are identical to those described in the preceding figures. Also, the central portions 27′ have the same thickness T and width W relationship as described above relative to the preceding figures. However, the lower ends of flexures 25′ are secured to vibratory frame side 14 in a slidable manner. In this respect, clamping members 50 are mounted on plate 41″ which is analogous to plates 41 and 41′ of the preceding figures and which is welded to plate 42 which in turn is bolted to vibratory frame side 14 by bolts 43 as described above relative to FIG. 4. The clamping structure 50 includes a section 51 which is of rectangular configuration as seen from FIG. 13 and which is also of the configuration as seen from FIG. 14 and which has an end 52 which is welded to plate 41″. Portion 51 includes a slot 53 which is of a configuration to slidingly receive one side of the end portion of central portion 27′ of flexure 25′ in complementary mating relationship. The clamping structure also includes a block 54 having a slot 55 therein which receives the opposite side of flexure portion 27′ in complementary sliding relationship. When bolts 57 are loosened, portions 27′ of flexures 25′ can be slid between the parts 51 and 54 of clamping structures 50 to a desired position and thereafter bolts 57 are tightened. Thus, when the length of the flexures is longer, they will be more flexible and thus convey less thrust to the vibratory frame 14 to result in ellipses with smaller minor axes. When the length of the flexures 25 are shortened, more thrust will be conveyed to the vibratory frame 14 and thus ellipses with larger minor axes will be generated.

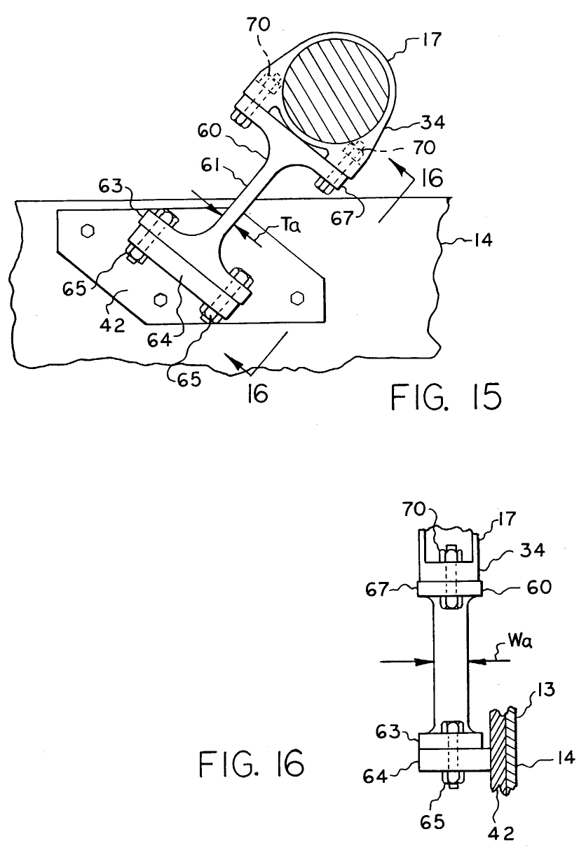

In FIGS. 15 and 16 another embodiment of the present invention is disclosed. The body of each flexure 60, which is mounted at each end of vibratory motor 17, is in the general shape of an I-beam of suitable dimensions with the width dimension Wa of its flexible web 61 extending substantially perpendicularly to the side 14 of the vibratory frame 13 and its thickness dimension Ta extending substantially perpendicularly to its width dimension Wa. As can be seen, the width dimension Wa is larger than the thickness dimension Ta so that the web 61 will be flexible in the direction of thickness Ta, but it will be rigid in the directions of the width Wa and its length. The lower flange 63 of flexure 60 is bolted to bar 64 by bolts 65. Bar 64 is welded to a plate, such as 42 (FIG. 4), which in turn is bolted to side 14 of vibratory frame 13. The upper flange 67 of flexure 60 is bolted to bracket 34 of vibratory motor 17 by bolts 70.

The flexure 60 of FIGS. 15 and 16 will operate in substantially the same manner as described above for flexures 25. It will be appreciated that the characteristic of an ellipse which is generated will depend on the thickness Ta of web 61 and its length. As noted above relative to flexures 25, the minor axis of an ellipse will decrease proportionately with the thickness Ta. Also if desired for adjustability, the lower flange 63 can be eliminated and the lower end of central portion 61 can be mounted by a clamping construction, such as shown in FIGS. 12-14.

While the embodiments of FIGS. 4-14 have shown two flexures on each end of the vibratory motor, and while the embodiment of FIGS. 15 and 16 has shown one flexure at each end of the motor, it will be appreciated that more than two flexures can be installed at each end of the vibratory motor.

While various modifications of the various structures have been disclosed, it will be appreciated that various structural features of the various figures may be combined with each other unless they are incompatible.

The flexures 25 have been made from 4140 steel having a C31 Rockwell hardness, and it should not be subjected to a stress which is greater than 60,000 psi in operation. However, it will be appreciated that they can be made of any other suitable steel.

While preferred embodiments of the present invention have been disclosed, it will be appreciated that the present invention is not limited thereto but may be otherwise embodied within the scope of the following claims.

1. In a vibratory screening machine having a vibratory frame with opposite sides and a single vibratory motor having opposite ends for vibrating said vibratory frame, the improvement of a vibratory motor support structure between said vibratory frame and said single vibratory motor comprising flexures having first ends mounted on said opposite ends of said vibratory motor and second ends mounted on said opposite sides of said vibratory frame, each of said flexures having a width dimension and a thickness dimension which is smaller than said width dimension, said width dimensions extending substantially perpendicularly to said opposite sides, and said thickness dimensions extending substantially perpendicularly to said width dimension.

2. In a vibratory screening machine as set forth in claim 1 including adjusting means for adjustably mounting said second ends on said opposite sides.

3. In a vibratory screening machine as set forth in claim 2 wherein said adjusting means comprise slidable connections between said flexures and said sides of said vibratory frame.

4. In a vibratory screening machine as set forth in claim 2 wherein said adjusting means comprise plates on which said second ends are fixedly mounted, and slotted connections between said plates and said sides of said vibratory frame.

5. In a vibratory screening machine as set forth in claim 1 wherein said ends of said vibratory motor are mounted on said first ends of said flexures by bolt connections.

6. In a vibratory screening machine as set forth in claim 5 wherein said second ends of said flexures are mounted on said sides of said vibratory frame by second bolt connections.

7. In a vibratory screening machine as set forth in claim 1 wherein a plurality of said flexure members are mounted at each of said ends of said vibratory motor.

8. In a vibratory screening machine as set forth in claim 1 wherein a single flexure member is mounted at each end of said vibratory motor.

9. In a vibratory screening machine as set forth in claim 8 wherein each flexure member is in the shape of an I-beam.

10. A support structure for mounting a vibratory motor on a vibratory frame of a vibratory screening machine comprising spaced flexure members for mounting between the ends of a vibratory motor and the vibratory frame of a vibratory screening machine, each of said flexure members having a first end for connecting to said vibratory motor, and a second end for connecting to said vibratory frame of said vibratory screening machine.

11. A support structure for a vibratory motor as set forth in claim 10 including means for adjustably mounting said second ends on said vibratory frame.

12. A support structure for a vibratory motor as set forth in claim 10 wherein each of said flexures is longer than it is wide.

13. A support structure for a vibratory motor as set forth in claim 10 wherein said first end includes a bolt thereon.

14. A support structure for a vibratory motor as set forth in claim 13 wherein said second end includes a bolt thereon.

15. A support structure for a vibratory motor as set forth in claim 10 wherein said second end includes a bolt thereon.

16. A support structure for a vibratory motor as set forth in claim 10 wherein each flexure member is in the shape of an I-beam.

17. A support structure for a vibratory motor as set forth in claim 16 wherein said first end is the flange of said I-beam.

18. A support structure for a vibratory motor as set forth in claim 17 wherein said second end is a second flange of said I-beam.

19. A flexure for supporting a vibratory motor on a vibratory frame of a vibratory screening machine comprising a body having first and second ends, a flexible central portion on said body having a width which is larger than its thickness, first means for securing said first end of said body to a vibratory motor, and second means for securing said second end of said body to the vibratory frame of a vibratory screening machine.

20. A flexure as set forth in claim 19 wherein said body has a length which is larger than said width.

21. A flexure as set forth in claim 19 wherein said first means comprise an enlarged portion on said first end of said body having a bolt thereon.

22. A flexure as set forth in claim 21 wherein said second means comprise a second enlarged portion on said second end of said body having a second bolt thereon.

23. A flexure as set forth in claim 19 wherein said second means comprises an enlarged portion on said second end of said body having a bolt thereon.

24. A flexure as set forth in claim 19 wherein said second means is an extension of said central portion.

25. A flexure as set forth in claim 19 wherein said body is in the shape of an I-beam.

26. A flexure as set forth in claim 25 wherein said first means comprises a flange of said I-beam.

27. A flexure as set forth in claim 26 wherein said second means comprises a second flange of said I-beam.
